(19) United States
(12) Patent Application Publication
(10) Pub. No.: US 2025/0346131 A1
(43) Pub. Date: Nov. 13, 2025

(54) ELECTRIC VEHICLE CHARGER MAGNETIC ADAPTER

(71) Applicant: SWTCH Energy Inc., Toronto (CA)

(72) Inventor: Carter LI, Toronto (CA)

(21) Appl. No.: 18/660,512

(22) Filed: May 10, 2024

(51) Int. Cl. B60L 53/16; H01R 13/62; H01R 31/06

(52) U.S. Cl. CPC B60L 53/16; H01R 13/6205; H01R 31/06

(57) ABSTRACT

A charger adapter system for an electric vehicle charger. The electric vehicle charger can include a charger head and a charger hose. In an example, the charger adapter system includes: a port to port adapter, a first magnetic counterpart attached to the port to port adapter, a mount, a second magnetic counterpart attached to the mount, a tether connected to the port to port adapter; and a lock connected to the tether. In an example, the port to port adapter connects a first type of port of the electric vehicle charger to a second type of port of an electric vehicle. An example use of the charger adapter system comprises attaching the port to port adapter to the charger head. An example use of the charger adapter system comprises charging the electric vehicle using the electric vehicle charger. An example use of the charger adapter system comprises attaching the first magnetic counterpart to the second magnetic counterpart.

### TECHNICAL FIELD

Example embodiments relate to a charger adapter system for an electric vehicle charger.

### BACKGROUND

Hybrid and electric vehicles are becoming an increasingly popular alternative to traditional gasoline-powered vehicles. Plug-in hybrid or fully electric vehicles require a plug for charging, which may vary across models and charging stations.

Charging using alternating current (AC) is usually done in areas where charging speed is not a necessity and less electricity is available, such as at home or at work. These AC applications commonly use the SAE J1772 connector, which is also found in most plug-in hybrids and electric vehicles. In contrast, direct current (DC) charging is used for fast charging, and are usually found in gas stations, restaurants, or rest stops. These chargers may use a Combined Charging System, whereby the SAE J1772 charger is modified to include two high speed charging pins, or a CHAdeMO charger, which requires a specific compatible charging port.

However, the SAE J3400 charger is soon to become the North American Charging Standard, which adopts a single charging connector for both AC and DC charging. As such, public charging stations should ensure that their chargers are equipped with SAE J3400 chargers so that they can properly serve the market. However, completely replacing the chargers can prove costly, and will not allow the charging stations to service customers with older model plugs.

There is thus a need in the art for an electric vehicle charging system which can easily serve cars with different charging plugs, without requiring an overhaul of services offered by the charging stations. The charging system should be easily accessible and convenient, while remaining robust and functional through frequent use and securely stored when not being used.

### SUMMARY

Example embodiments relate to a charger adapter system for an electric vehicle charger that is used to charge an electric vehicle. For example, the charger adapter system can be securely stored when not in use.

An example embodiment is a charger adapter system for an electric vehicle charger having a charger head and a charger hose, comprising a port to port adapter, a first magnetic counterpart attached to the port to port adapter, a mount, a second magnetic counterpart attached to the mount, a tether connected to the port to port adapter, and a lock connected to the tether.

In an example, the port to port adapter connects a first type of port of the electric vehicle charger to a second type of port of the electric vehicle.

According to an example embodiment, the port to port adapter is for connection to the charger head, the mount is for connection to the charger hose, and the lock is for locking to the electric vehicle charger.

According to an example embodiment, the mount comprises a locking mechanism to restrict movement with respect to the charger hose.

According to an example embodiment, one of the first magnetic counterpart or the second magnetic counterpart is a first magnet and the other of the first magnetic counterpart or the second magnetic counterpart is a second magnet or ferromagnetic.

According to an example embodiment, the first magnet and/or the second magnet is a neodymium magnet.

According to an example embodiment, the port to port adapter defines a first cavity which has the first magnetic counterpart, and the mount defines a second cavity which has the second magnetic counterpart.

According to an example embodiment, the port to port adapter further comprises a first cover which covers the first cavity.

According to an example embodiment, the first cover comprises silicone.

According to an example embodiment, the port to port adapter further comprises a second cover which covers the second cavity.

According to an example embodiment, the second cover comprises silicone.

According to an example embodiment, the port to port adapter is a J1772 to J3400 adapter.

According to an example embodiment, the mount comprises a cylindrical clamp.

According to an example embodiment, the mount is cylindrical.

According to an example embodiment, the lock is connected to a first end of the tether, and the port to port adapter is connected to a second end of the tether.

According to an example embodiment, the lock is a ring lock.

According to an example embodiment, the ring lock is unitary.

According to an example embodiment, the ring lock has a diameter which is less than a maximum width of the charger head.

According to an example embodiment, the port to port adapter is for connecting to the charger hose.

According to an example embodiment, the port to port adapter is for connection to a distal end of the charger head.

According to an example embodiment, wherein the tether comprises of a metal wire.

According to an example embodiment, the tether is coated in one or more of polyester, silicon, or rubber.

According to an example embodiment, the charger adapter system comprises the electric vehicle charger.

Another example embodiment is use of any of the above charger adapter systems, comprising: attaching the port to port adapter to the charger head.

Another example embodiment is use of any of the above charger adapter systems: charging an electric vehicle using the electric vehicle charger.

Another example embodiment is use of any of the above the charger adapter systems comprising attaching the first magnetic counterpart to the second magnetic counterpart.

### BRIEF DESCRIPTION OF THE DRAWINGS

FIG. 1 is a front perspective view of a port to port adapter for an electric vehicle charger.

FIG. 2 is a front perspective view of the port to port adapter of FIG. 1 showing a first counterpart of an attachment mechanism.

FIG. 3 is a rear perspective view of the port to port adapter of FIG. 1.

FIG. 4 is a front perspective view of a cylindrical mount.

FIG. 5 is a front perspective view of the cylindrical mount of FIG. 4 showing a second counterpart of the attachment mechanism.

FIG. 6 is a top-down view of the cylindrical mount of FIG. 4.

FIG. 7 is a front perspective view of a ring lock for locking to the electric vehicle charger.

FIG. 8 is a perspective view of a charger adapter system including the port to port adapter, cylindrical mount, and ring lock for attaching to the electric vehicle charger.

FIG. 9 is a perspective view of the system of FIG. 8, wherein the port to port adapter is detached from the electric vehicle charger.

FIG. 10 is a perspective view of the system of FIG. 9, wherein the port to port adapter is reversibly attached to the circular clamp.

### DETAILED DESCRIPTION OF THE DRAWINGS

Reference is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout.

Throughout the following, specific details are set forth in order to provide a more thorough understanding to persons skilled in the art. However, well-known elements may not have been shown or described in detail. Accordingly, the description and drawings are to be regarded in an illustrative, rather than a restrictive, sense.

Example embodiments relate to a charger adapter system for an electric vehicle charger that is used to charge an electric vehicle. For example, the charger adapter system can be securely stored when not in use.

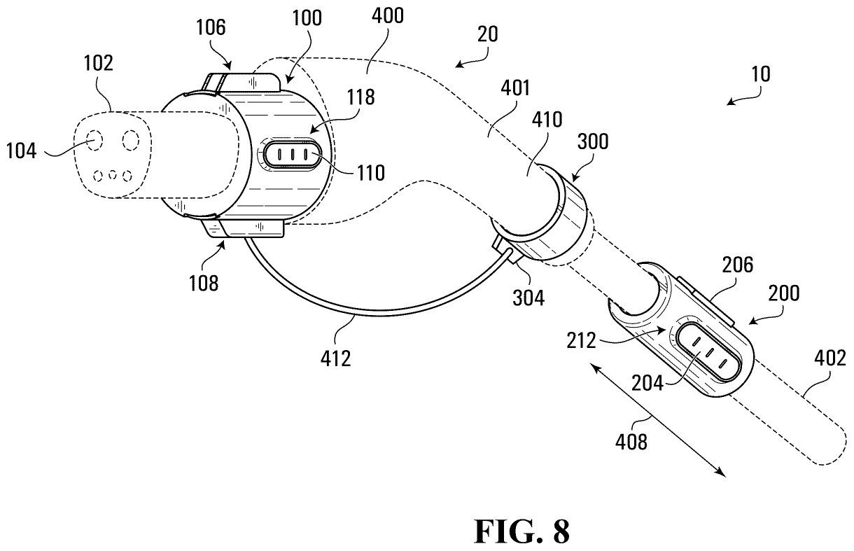

Referring first to FIG. 8, an example charger adapter system 10 is illustrated, which is used for adapting a charger 20. The charger 20 includes a charger head 400, a charger handle 401, and a charger hose 402. The charger 20 is used to recharge the battery of a vehicle (not shown), for example an electric vehicle, by connecting charging head 400 to the electrical port of the electric vehicle. The charger 20 and may be wired to a standard electrical outlet or to a dedicated charging station (not shown).

In an example, the charger adapter system 10 includes a port to port adapter 100, a cylindrical mount 200, and a ring lock 300. The charger adapter system 10 is configured to securely store the port to port adapter 100 when not in use. For example, the port to port adapter 100 may be magnetically attachable to the cylindrical mount 200 when the port to port adapter 100 is not connected to charger 400. Ring lock 300 is connected to port to port adapter 100 via tether 412 to prevent separation of the port to port adapter 100 from the charger 20. Cylindrical mount 200 is slidable along charger hose 402 to accommodate varying lengths of tether 412.

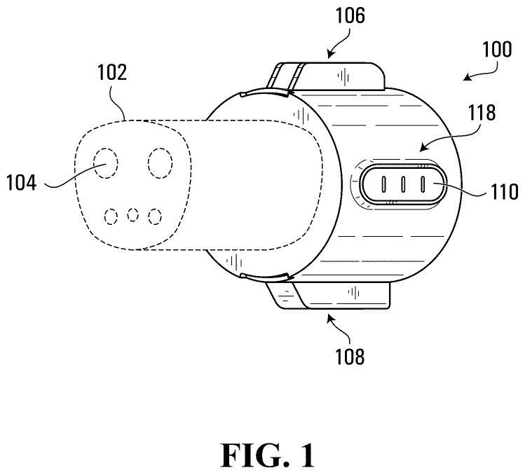

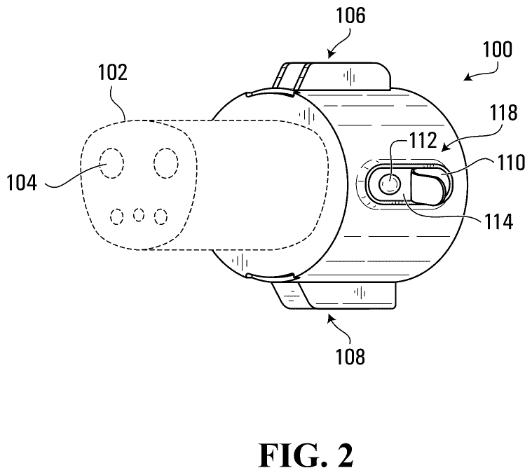

Referring now to FIG. 1, an example electric charger adapter is illustrated, which in an example is a port to port adapter 100. The port to port adapter 100 is for connection to a distal end of a charger head 400 of the charger 20. The port to port adapter 100 has a protruding nose 102, containing male pins 104. The port to port adapter 100 connects a first type of port (of the charger) to a second type of port (of the electric vehicle). In an example, the port to port adapter 100 is a SAE J1772 to SAE J3400 port to port charging plug adapter. The pins 104 are arranged in an SAE J3400 configuration, allowing for AC and DC charging. The charging port to port adapter 100 has upper protrusions 106 and lower protrusions 108. The port to port adapter 100, the protruding nose 102 and the protrusions 106 and 108 may be made of any suitable, durable, weather resistant material, such as metal, plastic, composite material, or the like. The port to port adapter 100 contains a cover 110, which shelters the first counterpart of the attachment mechanism (e.g., as shown in FIG. 2). This cover 110 may be made out of any suitable water and weather resistant material, such as silicone. In an embodiment, the cover 110 is permanently affixed to the port to port adapter 100.

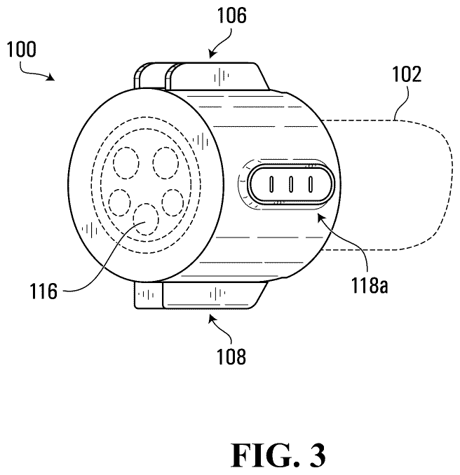

Referring now to FIG. 2, the first counterpart of the attachment mechanism is illustrated, for example a first magnetic counterpart 118. In an example embodiment, the first magnetic counterpart 118 is a magnet 112 is disposed within a cavity 114 of the port to port adapter 100. This magnet may be made from any suitable material that produces a strong magnetic field, such as neodymium, samarium cobalt, or alnico (aluminum, nickel, and cobalt). In an alternative embodiment, the first magnetic counterpart 118 may be an electromagnet. In an alternative embodiment, the first magnetic counterpart 118 may be a ferromagnetic material. Other examples of the first counterpart of the attachment mechanism may comprise any reversible attachment method as understood in the art. In an embodiment, as best shown in FIG. 3, the port to port adapter 100 may have another instance of the first magnetic counterpart 118a disposed on the other side of the port to port adapter 100.

FIG. 3 illustrates the female pin connections 116 on the back of port to port adapter 100, which are configured for a SAE J1772 charging configuration. Electrical wiring disposed within the port to port adapter 100 converts the current from the SAE J1772 charging configuration to the SAE J3400 configuration. Electrical wiring to change charging configurations are understood in the art and not described further herein. A person of skill in the art understands that several hardware and electrical embodiments for conversion are possible, all of which are covered by example embodiments.

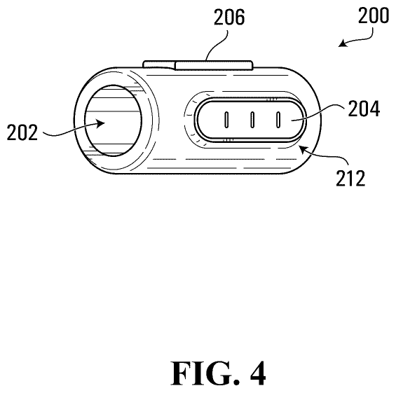

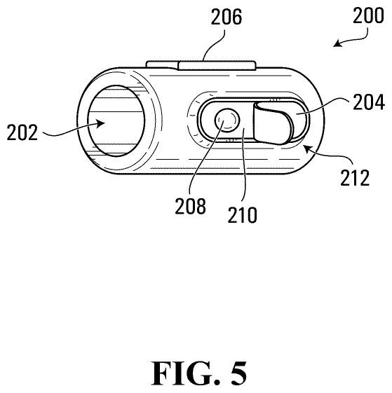

FIG. 4 illustrates an embodiment of a mount, such as cylindrical mount 200 which is configured to wrap around the charger hose 402. The cylindrical mount 200 has an inner diameter 202 which is slightly larger than the outer diameter of charger hose 402. The cylindrical mount 200 may be made of the same material as the port to port adapter 100, or a different material, such as any suitable durable weather resistant material. The cylindrical mount 200 has a cover 204 which shelters the attachment mechanism (e.g., see FIG. 5). This cover 204 may be made of the same material as port to port adapter cover 110, or a different material. In an embodiment, the cover 204 may be permanently affixed to cylindrical mount 200. The cylindrical mount 200 has a locking mechanism 206 which is designed to tighten the mount 200 around the charger hose 402, such that movement is locked.

As seen in FIG. 5, cylindrical mount 200 may include a second counterpart of the attachment mechanism as in port to port adapter 100, comprising a second magnetic counterpart 212. The second magnetic counterpart 212 can be used to magnetically attach to the first magnetic counterpart 118. In an example, the second magnetic counterpart 212 has an exterior facing pole that is an opposite polarity to the exterior facing pole of the first magnetic counterpart 118.

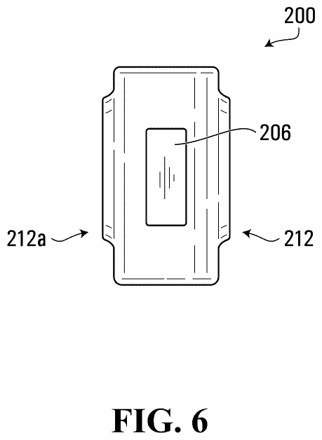

In an example, the second magnetic counterpart 212 is a magnet 208 which may be disposed in a cavity 210 of the cylindrical mount 200, which may the same type as magnet 112 or may be made from the same material as magnet 112 or a different material. In an alternative embodiment, the second magnetic counterpart 212 may be an electromagnet. In an alternative embodiment, the second magnetic counterpart 212 may be a ferromagnetic material. The second magnetic counterpart 212 is reversibly attachable to the first magnetic counterpart 118. Although several embodiments have been described, at least one of the first magnetic counterpart 118 or the second magnetic counterpart 212 should contain a magnet. In an embodiment, as best shown in FIG. 6, the cylindrical mount 200 may have another instance of the second magnetic counterpart 212a on the other side of the locking mechanism 206.

FIG. 6 illustrates the locking mechanism 206. In one embodiment, the locking mechanism 206 may be a sliding member which increases the force exerted on the charger hose 402 by the inner diameter 202. In another embodiment, the locking mechanism 206 may be a clasp which tightens around the cylindrical mount 200 when tightened. In another embodiment, the locking mechanism may comprise protrusions which are extended and exert a force onto the charger hose 402. A person of skill in the art understands that one or more tightening mechanisms may be employed to prevent movement of the cylindrical mount 200 and examples given are exemplary, not exhaustive.

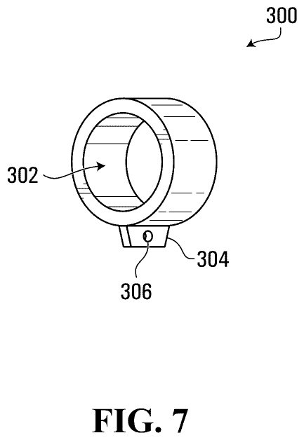

FIG. 7 illustrates a lock, shown as ring lock 300, which is lockable to the charger head 400. In an example, the ring lock 300 has an inner diameter 302 which may be slightly larger than the diameter of the charger hose 402. Ring lock 300 also has a protrusion 304, which contains a hole 306. Ring lock 300 may be made out of the same or different material as port to port adapter 100 and cylindrical mount 200. The ring lock 300 may also be unitary. In an embodiment, ring lock 300 may have more than one protrusion 304.

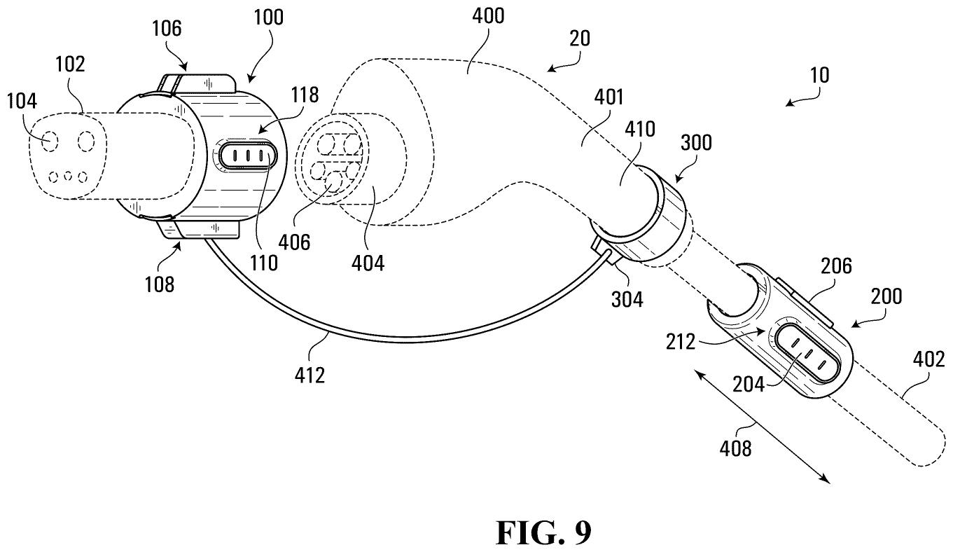

Referring now to FIG. 8 and FIG. 9, the charger adapter system 10 containing port to port adapter 100, cylindrical mount 200, ring lock 300, and the charger 20. In an embodiment, the charger head 400 is equipped with an SAE J1772 charging configuration 404 with male charging pins 406. The female pin connections 116 on the back of port to port adapter 100 can be mounted on the male charging pins 406, physically and electrically connecting the port to port adapter 100 to the charger head 400. As shown, the inside of the cylindrical mount 200 is concentric with charger hose 402. The cylindrical mount 200 is free to move along axis 408 when unlocked and is prevented from moving when locked.

In an embodiment, ring lock 300 is secured to the base of the charger handle 401 through a press fit in the taper 410 of the charger handle 401. The ring lock 300 may be secured by other means, including screws, bolts, rivets, or any other type of fastener. In an embodiment, the ring lock 300 may be installed on the connection port of the charger hose 402, and then charger handle 401 may be installed on top of ring lock 300, thereby securing ring lock 300 in place. In an embodiment, the inner diameter of the ring lock 300 is less than a maximum width of the charger handle 401, therefore securing the ring lock 300 from accidental or intentional removal.

Port to port adapter 100 is connected to the ring lock 300 via a tether, such as a metal wire 412. The metal wire 412 may be secured to both port to port adapter 100 and ring lock 300 through the respective protrusions. The metal wire 412 may be manufactured out of any metal that is strong yet flexible. In an embodiment, the metal wire 412 may be wrapped with a material such as polyester, silicon or rubber to protect from environmental wear and to ensure safe handling by users. The metal wire 412 keeps the port to port adapter 100 attached to the ring lock 300 and therefore to the charger handle 401 and charger hose 402, preventing theft or misplacement of the port to port adapter 100. Due to the locking/unlocking mechanism of the cylindrical mount 200, the position of the cylindrical mount 200 on the charger hose 402 can be changed to accommodate varying lengths of metal wire 412.

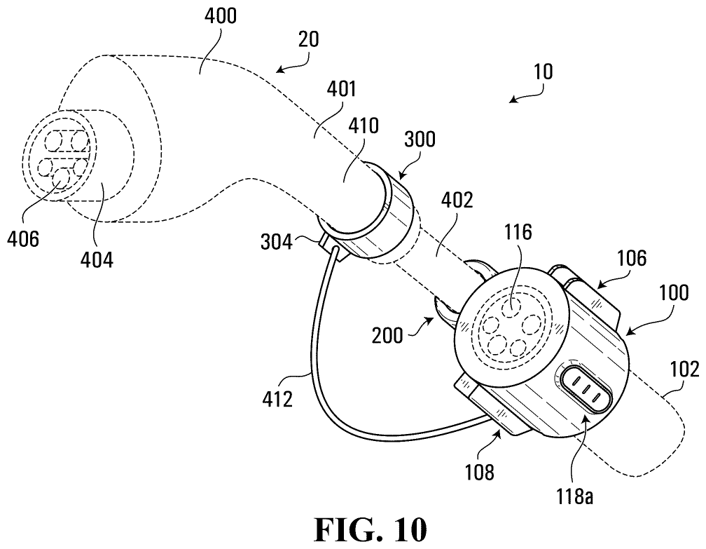

FIG. 10 illustrates a non-use configuration of the port to port adapter 100 whereby the port to port adapter 100 is reversibly attached to the cylindrical mount 200 via the respective attachment mechanisms. As pictured, the port to port adapter 100 is kept securely out of the way of the charger head 400, allowing a user to charge a vehicle with the default charging configuration without obstruction from the port to port adapter 100.

The port to port adapter 100, the cylindrical mount 200, and the ring lock 300 can all be easily fitted and attached to existing electric vehicle chargers, meaning that the electric vehicle chargers to not have to be redesigned or modified to accommodate the charger adapter system. This means that the charger adapter system can be conveniently added to public or private charging stations without incurring additional setup or maintenance costs.

While some of the above examples have been described as occurring in a particular order, it will be appreciated to persons skilled in the art that some of the steps or processes may be performed in a different order provided that the result of the changed order of any given step will not prevent or impair the occurrence of subsequent steps. Furthermore, some of the steps described above may be removed or combined in other embodiments, and some of the steps described above may be separated into a number of sub-steps in other embodiments. Even further, some or all of the steps may be repeated, as necessary. Elements described as methods or steps similarly apply to systems or subcomponents, and vice-versa.

Variations may be made to some example embodiments, which may include combinations and sub-combinations of any of the above. The various embodiments presented above are merely examples and are in no way meant to limit the scope of the examples. Variations of the innovations described herein will be apparent to persons of ordinary skill in the art having the benefit of the examples, such variations being within the intended scope of the example embodiments. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the example embodiments as a whole. The subject matter described herein intends to cover and embrace all suitable changes in technology.

Certain adaptations and modifications of the described embodiments can be made. Therefore, the above discussed embodiments are considered to be illustrative and not restrictive.

What is claimed is:

1. A charger adapter system for an electric vehicle charger having a charger head and a charger hose, comprising:
a port to port adapter;
a first magnetic counterpart attached to the port to port adapter;
a mount;
a second magnetic counterpart attached to the mount;
a tether connected to the port to port adapter; and
a lock connected to the tether.

2. The charger adapter system of claim 1, wherein the port to port adapter is for connection to the charger head, the mount is for connection to the charger hose, and the lock is for locking to the electric vehicle charger.

3. The charger adapter system of claim 2, wherein the mount comprises a locking mechanism to restrict movement with respect to the charger hose.

4. The charger adapter system of claim 1, wherein one of the first magnetic counterpart or the second magnetic counterpart is a first magnet and the other of the first magnetic counterpart or the second magnetic counterpart is a second magnet or ferromagnetic.

5. The charger adapter system of claim 4, wherein the first magnet and/or the second magnet is a neodymium magnet.

6. The charger adapter system of claim 4, wherein the port to port adapter defines a first cavity which has the first magnetic counterpart, and the mount defines a second cavity which has the second magnetic counterpart.

7. The charger adapter system of claim 6, further comprising a first cover which covers the first cavity.

8. The charger adapter system of claim 7, wherein the first cover comprises silicone.

9. The charger adapter system of claim 6, further comprising a second cover which covers the second cavity.

10. The charger adapter system of claim 9, wherein the second cover comprises silicone.

11. The charger adapter system of claim 1, wherein the port to port adapter is a J1772 to J3400 adapter.

12. The charger adapter system of claim 1, wherein the mount comprises a cylindrical clamp.

13. The charger adapter system of claim 1, wherein the mount is cylindrical.

14. The charger adapter system of claim 1, wherein the lock is connected to a first end of the tether, and the port to port adapter is connected to a second end of the tether.

15. The charger adapter system of claim 1, wherein the lock is a ring lock.

16. The charger adapter system of claim 15, wherein the ring lock is unitary.

17. The charger adapter system of claim 15, wherein the ring lock has a diameter which is less than a maximum width of the charger head.

18. The charger adapter system of claim 1, wherein the port to port adapter is for connecting to the charger hose.

19. The charger adapter system of claim 1, wherein the port to port adapter is for connection to a distal end of the charger head.

20. The charger adapter system of claim 1, wherein the tether comprises a metal wire.

21. The charger adapter system of claim 1, wherein the tether is coated in one or more of polyester, silicon, or rubber.

22. The charger adapter system of claim 1, further comprising the electric vehicle charger.

23. Use of the charger adapter system of claim 22, comprising: attaching the port to port adapter to the charger head.

24. Use of the charger adapter system of claim 23, comprising: charging an electric vehicle using the electric vehicle charger.

25. Use of the charger adapter system of claim 1, comprising: attaching the first magnetic counterpart to the second magnetic counterpart.
